(19) United States
(12) Patent Application Publication
(10) Pub. No.: US 2019/0135318 A1
(43) Pub. Date: May 9, 2019

(54) RAIL FLEET MAINTENANCE MANAGEMENT SYSTEM AND METHOD

(71) Applicant: RailCarRx, Inc., Irving, TX (US)

(72) Inventors: Anil Kilaru, Southlake, TX (US); Joseph Lippy, Swansboro, NC (US); Sitaram Mohan Kodali, Cottonwood Heights, UT (US)

(73) Assignee: RailCarRx, Inc., Irving, TX (US)

(21) Appl. No.: 16/180,081

(22) Filed: Nov. 5, 2018

Related U.S. Application Data
(60) Provisional application No. 62/581,086, filed on Nov. 3, 2017.

(51) Int. Cl. B61L 27/00; G07C 5/08

(52) U.S. Cl. CPC B61L 27/0094; G06Q 50/30; G07C 5/08

(57) ABSTRACT

The present invention relates generally to maintenance management systems and methods, particularly for rail car fleets. The system includes a web-based software system for identifying high-risk equipment and identifying and facilitating maintenance and repair options. The preferred embodiment of the present invention comprises three main modules: (1) fleet data management and analysis; (2) bid management and Request for Quote (“RFQ”); and (3) shop management. It is deployed in a cloud-based software environment, giving users maximum flexibility to manage their railcar fleets and optimize the process of maintaining their railcars.

This application claims priority to U.S. Provisional Application No. 62/581,086, filed on Nov. 3, 2017. Pursuant to 35 U.S.C. 119(e)(3) and MPEP §§ 201.04 and 710.05, the present application is timely filed on the first business day following the twelve-month expiration date of the above-cited application, which fell on a Saturday. The disclosure of the above-cited application is incorporated by reference in its entirety.

### FIELD OF THE INVENTION

The present invention relates generally to maintenance management systems and methods, particularly for rail car fleets but applicable to fleets of other vehicles, as well (e.g., trucks, cargo ships, planes). The system includes a web-based software system for identifying high-risk equipment, avoiding or lowering potential demurrage charges, and identifying and facilitating maintenance and repair options. This system and method helps reduce the costs of railcar maintenance and repair.

### COPYRIGHT NOTICE

The present invention and portions of the disclosure of this patent document contain materials that are subject to copyright protection. The copyright owner has no objection to the facsimile reproduction by anyone of the patent disclosure, as it appears in the Patent and Trademark Office patent, files, or records, but otherwise reserves all copyright rights whatsoever.

### BACKGROUND OF THE INVENTION

There are over one hundred forty thousand route miles of railroad tracks in the United States alone, serving traveling passengers and freight. These tracks span across the entire nation, providing equipment owners or managers literally with a nationwide footprint for the distribution of goods and services. Railcar owners or fleet managers are often tasked with not only keeping track of their equipment and inventory but also monitoring their equipment for maintenance and repair needs.

In the past, rail fleet maintenance plans generally required owners or managers to search manually through equipment health data and internal data to diagnose issues and make purchasing or repair decisions. Outsourcing operations to third party providers was common. These third parties provided audits of repair bills but were not typically capable of determining the opportune time to shop equipment, thus increasing overall maintenance costs.

Accordingly, there has long existed a technological problem associated with facilitating and optimizing repairs across a nationwide footprint from a central management hub. While there are other systems in the marketplace that help address certain aspects of this problem, there does not currently exist a robust and comprehensive technological solution. For example, other systems in the marketplace collect industry data to assess equipment health and/or audit estimates and invoices. But these systems do not provide a risk rules engine to help make shopping decisions and reduce maintenance costs.

One concern among equipment owners and managers is how to filter through data and find actionable information in a timely and efficient manner. The inability to do this in standard organizations contributes to loss of time and money for owners and managers. Additionally, if a railroad identifies a problem or maintenance need in a particular railcar, they may take the initiative to have it repaired on their own, charging the owner or fleet operator for the cost. This can be more expensive for the railcar owner or fleet operator, who may prefer to identify potential problems before they occur and/or shop for competitive prices within the area where the repair or maintenance ultimately occurs.

The present invention is intended to help equipment owners and fleet managers better understand equipment maintenance needs and options for repair, replacement, or other actions. Equipment owners and fleet managers often struggle with budgeting for equipment maintenance. Costs can vary from year to year and also based on the geographic location where repairs or other maintenance are performed, as a railcar may be anywhere within a service footprint when such actions are needed. For example, a railcar may be in an urban area with more available repair options and price competition or may be in a rural area where a lone repair shop has more of a monopoly on the local market. Additionally, availability of needed parts may vary based on geography or other factors. Costs can also vary from year to year. For most rail equipment owners, a large portion of their budget is devoted to equipment maintenance. Knowing what equipment is at risk of raising maintenance costs and diverting that equipment to a repair shop at a much lower cost to repair can help reduce necessary spending. As the system continuously monitors equipment, it ensures that the fleet manager is kept apprised of high-risk equipment. One object of the present invention is to provide a system to allow owners and fleet managers to find the most cost effective and efficient options for railcar repair and maintenance. Ideally, information can be processed and decisions can be made to optimize maintenance tasks and contract for repair or maintenance at a lower cost before a third-party railroad performs the repair at a much higher cost. With the present invention, equipment owners and fleet managers can be more proactive in identifying equipment in need of repair rather than simply reacting to needs after they arise. These owners and managers can bid repairs to shops and manage the shop estimate and invoice process all from a single platform, helping reduce maintenance costs.

### SUMMARY OF THE INVENTION

The present invention can generally be described as a cloud-based rail fleet management software system and method. The preferred embodiment of the present invention is a web-based software system that enables rail equipment owners to determine the best opportunity to repair rail equipment.

The system allows a railcar fleet owner or manager to input all equipment data into a web-based system. This data may include equipment specifications and related projects or regulatory information. The system provides a user-configured risk rules engine that allows the railcar fleet owner or manager to set up rules to run against industry data to analyze industry data for equipment alerts that could be repaired by a railroad at the owner's expense. The risk rules engine also allows the user to configure geographical rules, equipment-based rules, and commodity rules against equipment. The system also allows the user to capture average repair costs within their shop network. The system assigns each piece of equipment a risk percentage and provides cost comparison reporting, which includes the cost comparison of repair done by railroads and repair by contract repair shops. The system also helps to track equipment and locate repair facilities that can service equipment at its destination. It can send out competing and non-competing bids to shops, accept bids, and allocate equipment to shops. The system also serves as a collection tool for shop estimates and invoices and allows for seamless communication between these two entities until the equipment is released back into service.

One preferred embodiment of the present invention comprises a comprehensive solution with three main components: (1) fleet data management and risk analysis; (2) Request for Request for Quote (“RFQ”) & bid management; and (3) shopping record management.

It is one object of the present invention to provide a cloud-based platform for users to track railcars and manage anticipated or actual repair or maintenance needs.

It is a further object of the present invention to provide a system that automates the repair decision process by allowing a user to configure a rules engine to help determine equipment in need of repair.

It is a further object of the present invention to provide a system that allows owners or fleet managers the ability to compare potential maintenance bids from shops, thus optimizing the shopping experience and minimizing time and cost associated with railcar maintenance.

It is a further object of the present invention to provide a system that allows owners or fleet managers to track railcars within a fleet based on a number of criteria, managing the movement of their cars to minimize or eliminate potential demurrage charges by generating waybills to move cars in and out of serving yards, terminal locations, and/or repair shops.

These objectives are illustrative in nature. Additional advantages and applications for the present invention will be readily apparent to persons skilled in the art upon a review of the invention and the disclosures contained herein.

### BRIEF DESCRIPTION OF THE DRAWINGS

The drawings referenced below are included so that the features and advantages of the presently disclosed invention may be better understood. It should be noted, however, that the attached drawings are meant only to be illustrative of particular embodiments of the invention and should not be considered limiting of its scope. The invention itself, as well as a preferred mode of use, further objectives and advantages thereof, will best be understood by reference to the following detailed description of the preferred embodiment when read in conjunction with the attached drawings, which are summarized below:

FIG. 1 is a comprehensive and cohesive system in accordance with an exemplary embodiment of the present invention.

FIG. 2 is a comprehensive and cohesive system in accordance with another embodiment of the present invention.

FIG. 3 depicts a sample process flow showing various aspects and system decisions in a preferred embodiment of the present invention.

FIG. 4 depicts a sample view of a graphical user interface of a system in accordance with a preferred embodiment of the present invention, showing a sample risk factor report.

FIG. 5 depicts a sample view of a graphical user interface of a system in accordance with a preferred embodiment of the present invention, showing a sample railcar information digest report.

FIG. 6 depicts a sample view of a graphical user interface of a system in accordance with a preferred embodiment of the present invention, showing a sample cost comparison report.

FIG. 7 depicts a sample view of a graphical user interface of a system in accordance with a preferred embodiment of the present invention, showing a sample report of available shops that have responded to a request for repair or maintenance quotes.

FIG. 8 depicts a sample view of a graphical user interface of a system in accordance with a preferred embodiment of the present invention, showing a sample tracking report of railcars within a fleet.

FIG. 9 depicts a sample process flow showing various aspects and system decisions in a tracking process module of the present invention.

### DETAILED DESCRIPTION OF THE INVENTION

Presently preferred embodiments of the invention are shown in the above-identified figures and described in detail below. In describing the preferred embodiments, like or identical reference numerals are often used to identify common or similar elements. The figures are not necessarily to scale, and certain features and certain views of the figures may be shown exaggerated in scale or in schematic in the interest of clarity and conciseness.

The present invention is a tool that enables fleet managers or equipment owners the ability to identify high risk equipment quickly, thereby saving money by shopping the equipment in a contract repair shop. The system continuously scans industry data to ensure that high risk equipment is captured as new alerts or warnings are added to equipment.

One preferred embodiment of the present invention comprises three main modules: (1) fleet data management and risk analysis; (2) Request for Quote (“RFQ”) & bid management; and (3) shopping record management.

The system of the present invention is preferably deployed as a distributed system with multiple components—some of which reside at central servers and some of which reside on distributed computer systems. For example, in the preferred embodiment of the present invention, the back-end data storage and processing are provided as a cloud-based web application. Optionally, individual data files may be stored locally on individual computer terminals or in a facility database that serves multiple user terminals. Additionally, graphical user interface information may be stored locally. Alternately, the system may be deployed as a software system that resides on users' own computers or within a system at a customer site. In this alternate scenario, the user's locally stored system would pull data from industry databases or compile industry and/or railcar reports for local storage and use within the system.

Additionally, the system preferably can access information across a network from third parties who collect and manage information about railcars and railroads. This information can be accumulated in a central database for accessing by the system when determining risk profiles, audits, or during other information processing.

### Fleet Data Management and Risk Analysis

The user of the present system has the ability to load each piece of equipment they own or manage into a web-based system. This data can be loaded directly into the user interface or via spreadsheet or integration to an outside data management system, as would be understood by a person of ordinary skill in the art. Uploaded data is stored in the system of the web-based system administrator. Such a system preferably houses the software necessary for running the web-based system for all customers (i.e., fleet managers or owners) who access the system from their own devices. After uploading equipment, the user can add mechanical details for all equipment including maintenance and regulatory projects that may be associated with rail equipment. In the absence of a user having mechanical data, the preferred system of the present invention possesses the ability to retrieve mechanical data from a third-party system such as the Railinc Umler system, which serves as the system of record for all rail equipment mechanical data for railcars in North America. The user also can further segment their fleet into sub fleets, for example, by car type, lessee, or business unit. Equipment can then be analyzed at the fleet level. After setting up fleets, the user may then set up the rules engine. The rules engine provides flexibility to set up risk factors that are most important to the equipment owner or fleet manager. The preferred embodiment of the present invention uses the risk rules and applies them against industry equipment health data from third parties (e.g., Railinc) including EHMS (Equipment Health and Maintenance System), DDCT (Damaged Defective Car Tracking), EW & MA (Early Warnings and Maintenance Advisories), as well as risk factors which can include things such as the identity of the railroad on which the equipment is traveling, the commodity it is carrying, the car types, etc. The risk rules engine runs against all these factors and provides a risk score to each piece of equipment to determine the probability of it being repaired by the railroad without the owner's consent at standard AAR repair rates. The system further provides a cost comparison of AAR repair rates against the equipment owner's average cost to perform the same repairs in a contract shop of their choice. As one non-limiting example, savings can be as high as 60% for a wheelset change out, a common AAR repair performed by railroads. The cost comparison report coupled with the risk factor scoring, known as the RID report (Railcar Information Digest) helps the fleet manager or equipment owner determine if the equipment should be repaired in their shop of choice, greatly reducing maintenance cost. Preferably, RID reports are auto-generated in real-time and can be retrieved by a user by clicking on an icon within the graphical user interface.

The fleet data management and risk analysis module includes a computer-implemented method and associated system for managing maintenance of one or more railcars in a fleet, comprising identifying a geographical location of a railcar; receiving sensor data associated with said railcar; retrieving, from a database, a maintenance report for said railcar, wherein said maintenance report includes at least a first maintenance history for a first hardware component of said railcar and a first maintenance schedule for said first hardware component; applying, with a processor, a risk rules engine to determine a first risk score for said first hardware component, wherein said first risk score is based at least in part on said geographical location, said sensor data, said first maintenance history, and said first maintenance schedule; and displaying said first risk score via a graphical user interface.

Moreover, as noted herein, sensor data can include data about the railcar itself, including the weight of said railcar, traveling speed, humidity, temperature, and other environmental factors. The system and method also include software configured to update the maintenance report for a given railcar with the determined risk score and store the updated maintenance report in a designated database—either locally or by sending the updated report to an off-site server.

Additionally, and as noted herein, the maintenance report for a given railcar may also include information associated with other hardware components, which may include maintenance histories and maintenance schedules for those hardware components. The system may generate risk scores for each hardware component based on the risk rules engine, and may rank the risk scores of each hardware component (creating a risk ranking) associated with a given railcar relative to each other so that a fleet owner or manager may determine the most important issues to address at any given time.

### Request for Request for Quote (“RFQ”) & Bid Management

After determining that equipment should be sent to a contract shop the preferred embodiment of the present system helps the fleet manager or equipment owner determine rail shops closest to the equipment's final destination. The system preferably utilizes track and trace data known as CLMs (Car Location Messages) to determine where the car will be at the end of its trip and provides railcar repairs shops within mileage radius determined by the user. When it is determined which equipment will be repaired, the user can send a competing or non-competing bid to shops of their choice. The system preferably generates a bid that includes all mechanical defects for each piece of equipment and any projects or regulatory items that are to be addressed. Each shop is sent this report along with the equipment account and can then respond with information such as back capacity, cost to repair, and timeframe for completion. The fleet manager or car owner can choose to accept one or multiple bids to send equipment for repair. The system preferably provides a dashboard to monitor all open, active, and closed RFQs and allows for drill down to indicate the status of all equipment being repaired under the RFQ, which is driven by the status updates from the shop, which are received via a shop portal.

### Shopping Record Management

In the preferred embodiment of the present invention, when equipment arrives at the repair shop, the repair shop is able to update arrival information and provide status updates via the shop portal, which is preferably part of the system. The system provides the fleet manager or equipment owner the ability to monitor how equipment is progressing through each repair facility and serves as a communication tool, allowing comments and messages to be sent via the system. The system also serves as a collection point for repair estimates and invoices from the shop and allows the fleet manager or equipment owner the ability to audit, accept, or reject repair lines and communicate this information back to the repair facility. The system also collects forms, images, and other data for each piece of equipment and stores it as an “Electronic Car File” for each shopping instance for equipment. After repairs are completed the car is released from the shop and enters back into the risk rules engine pool as described above. Importantly, a railroad or repair shop could also use portions of the system described herein to analyze inbound equipment for maintenance opportunities.

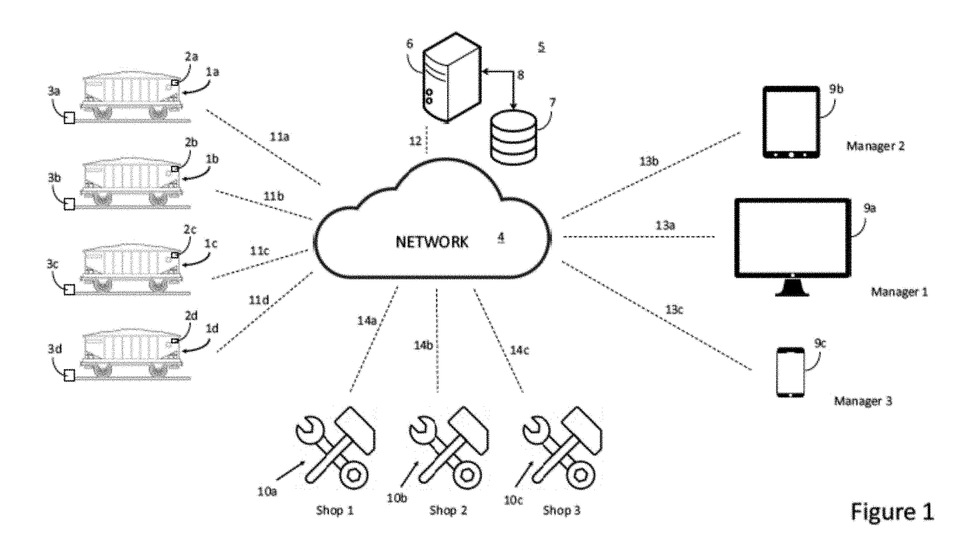

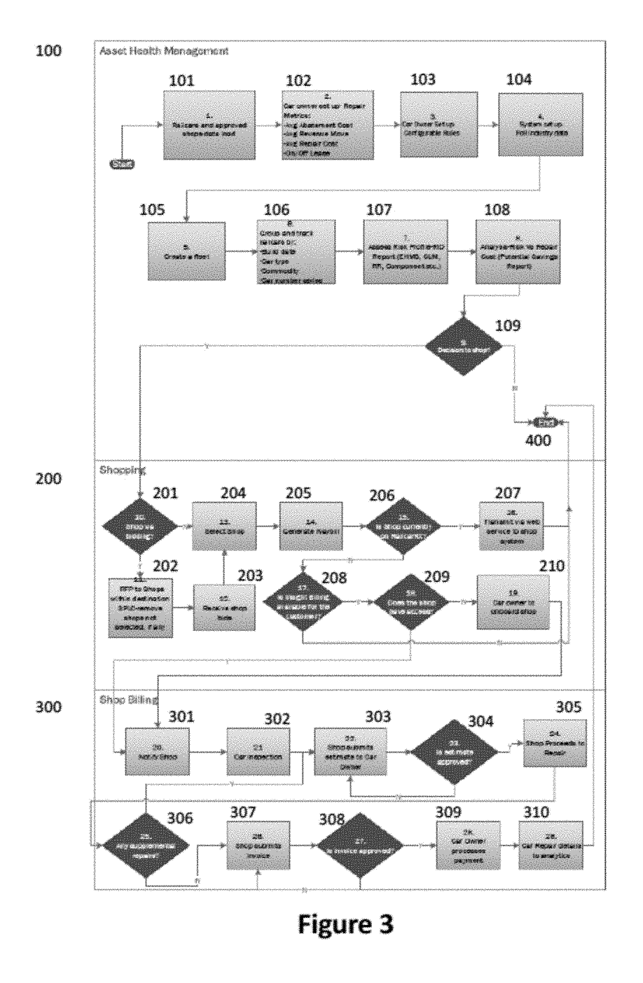

FIG. 1 is a comprehensive and cohesive system in accordance with an exemplary embodiment of the present invention. The system includes one or more railcars, 1a, 1b, 1c, and 1d, which are members of a railcar fleet. Each railcar 1a-d is connected to a network 4 via a network connection—e.g., railcar 1a is connected to network 4 via network connection 11a, railcar 1b is connected to network 4 via network connection 11b, railcar 1c is connected to network 4 via network connection 11c, and railcar 1d is connected to network 4 via network connection 11d. It will be understood by persons skilled in the art that a fleet of railcars 1a-d could have any number of cars; the designation of railcars 1a-d is illustrative for purposes of explanation only. The system also includes one or more user devices 9a, 9b, and 9c, which represent computers or other devices used by an owner or fleet manager. Any user device capable of network connection is suitable. For example, FIG. 1 shows user device 9a as a desktop computer, 9b as a tablet, and 9c as a mobile device like a smartphone. Each user device 9a-c is used by a fleet owner or manager to manage their fleet of railcars 1a-d. Accordingly, each user device 9a-c should be connected to network 4 via a network connection—e.g., user device 9a is connected to network 4 via network connection 13a, user device 9b is connected to network 4 via network connection 13b, and user device 9c is connected to network 4 via network connection 13c. The software components of the system may reside locally on a user device (e.g., user device 9a), may be accessed by the user device 9a from another computer or server within the user device 9a's local area network, or may be a cloud-based and/or web-based application, as will be understood by persons of ordinary skill in the art. The system also includes one or more subsystems 5 for storing data needed for fleet maintenance and analytics. Each such subsystem 5 may include one or more servers 6 connected via connection 8 to a database 7, where data is stored. It will be understood that the one or more server 6 and database 7 may reside on separate hardware components or on the same hardware, and that connection 8 may be any operable connection for transferring data between server and database. Subsystem 5 is also connected to network 4 via a network connection 12. The comprehensive and cohesive system described in FIG. 1 also includes one or more repair shops 10a, 10b, and 10c. As with the railcars 1a-d and fleet managers 9a-c , it should be understood that the number of repair shops 10a-c is illustrative only and could comprise any number of shops. The repair shops 10a-c are also connected to network 4 via a network connection—e.g., repair shop 10a is connected to network 4 via network connection 14a, repair shop 10b is connected to network 4 via network connection 14b, and repair shop 10c is connected to network 4 via network connection 14c. The overall process flow for the system of the present invention is described further in FIG. 3, below. In summary, the process of the system is broken down into three related parts: (1) an Asset Health Management phase; (2) a Shopping phase; and (3) a Shop Billing phase. In the Asset Health Management phase of the process, an owner or fleet manager first loads railcars 1a-d and approved shop data into the system via a user device 9a-c. Here, a railcar owner or fleet manager will load into the system information about the cars within a fleet, such as identifying information, age, previous maintenance, or other metrics that may be useful for tracking and managing maintenance needs. Next, the user sets up repair metrics, such as average abatement cost, average revenue move, average repair costs, and information regarding whether the car is on or off lease. The user next sets up configurable rules, described further below.

The next part of the Asset Health Management Phase involves system set-up, where data is pulled from an internal database (i.e., part of user device 9a-c or connected locally to user device 9a-c) or from a third-party industry database, such as may be housed at subsystem 5. This data includes information obtained from sensors attached to the railcars and/or railroads and is used to help assess the risk factors and needs of the railcars in a given fleet. For example, as shown in FIG. 1, each of railcars 1a-d may include an on-board sensor subsystem—e.g., railcar 1a includes sensor subsystem 2a, railcar 1b includes sensor subsystem 2b, railcar 1c includes sensor subsystem 2c, and railcar 1d includes sensor subsystem 2d. Each sensor subsystem 2a-d may collect data such as weight, temperature, humidity, traveling speed, location information (e.g., GPS), or other data. The system may also make use of sensors associated with the railroad, depicted in the example of FIG. 1 as node sensors 3a, 3b, 3c, and 3d, wherein node sensor 3a collects data associated with railcar 1a, node sensor 3b collects data associated with railcar 1b, node sensor 3c collects data associated with railcar 1c, and node sensor 3d collects data associated with railcar 1d. Sensor data collected from sensor subsystems 2a-d and/or node sensors 3a-d are sent over network connections 11a-d to network 4 where they can be retrieved for storage and/or use by subsystem 5, user devices 9a-c, and/or repair shops 10a-c, depending on the desired use and access permissions associated with each.

The system next allows the user operating, e.g., user device 9a, 9b, or 9c to create a fleet of railcars 1a-d. When a fleet is created, the system associates rail cars that are loaded into the system with each other and assigns them to a fleet manager or owner. Next, the system allows the user to group and track railcars by various features or characteristics such as build date, car type, commodity, or car number series. Next, the system assesses a risk profile and creates an RID Report. The rules risk engine uses the priority-based scoring system to apply the rules to the data about each of railcars 1a-d. For example, polled data may indicate that a particular railcar 1a-d (1) is carrying a hazardous material, (2) has a brake test due in 20 days, and (3) has a condemnable alert in the form of a wheel misalignment. Particular examples are discussed below in connection with FIG. 3. The risk information may be reported in a risk report through a graphical user interface presented on one of user devices 9a-c, as discussed further below.

The system next analyzes risk versus repair cost and generates a potential savings report, as discussed below. Once the initial steps outlined in the Asset Health Management Phase have been completed, a user can monitor reported data and make an informed decision whether to initiate a request for repairs via the Shopping Phase or End the session.

If a user decides to shop for repairs, the system next enters the Shopping Phase. The first decision in the Shopping Phase is whether to shop via bidding. If the user decides to shop via bidding, the system allows the user to send requests for proposal (“RFPs”) to shops near the destination SPLC. These may include repair shops 10a-c. The system also preferably allows the user, via the graphical user interface on one of user device 9a-c, to de-select any of repair shops 10a-c that the user does not want to include in the RFP list. Once a group of repair shops 10a-c is selected, the system sends RFPs to the selected shops and waits for responses. Next, the system receives bids from selected repair shops 10a-c with estimates or quotes for performing the desired repairs or maintenance. From here, the system allows the user to select one of repair shop 10a-c via user device 9a-c to perform the repair or maintenance. Note: if the user decides not to shop via bidding, the user can simply select a desired one of repair shop 10a-c. Once a shop is selected, a waybill is generated. Next, the system determines whether the selected repair shop 10a, 10b, or 10c has an existing shop record or object within the system database. If so, the system transmits to the repair shop 10a, 10b, or 10c record via network connection 14a-c. Further details of the Shopping Phase are discussed below in connection with FIG. 3.

Once a shop is selected and it is determined that the shop has access to Insight Billing (as discussed further below), the system proceeds to the Shop Billing phase. The first step in this phase is for the system to notify the selected repair shop 10a-c by sending an alert to the shop via network connection 14a-c. The railcar 1a-d at issue is then sent to the repair shop (10a, 10b, or 10c) where an inspection is performed. Next, the repair shop 10a-c submits an estimate to the railcar owner or operator (sent to network 4 via network connection 14a-c and received at user device 9a-c via network connection 13a-c). The user must then make an approval decision. If the user does not indicate that the estimate is approved, the repair shop 10a-c may submit a new estimate. If the estimate is approved, the repair shop 10a-c proceeds with the repair. Throughout the repair, the repair shop 10a-c may determine whether additional repairs are required. If so, the repair shop 10a-c can submit new estimates for these repairs, and the process flow continues as before. If no supplemental repairs are identified, the repair shop 10a-c completes the repairs and submits an invoice. The invoice is retrievable through the system via the GUI on user device 9a-c. If the invoice is approved, the car owner pays for the repairs, which may be facilitated through the system. Further details of the Shop Billing Phase are discussed below in connection with FIG. 3.

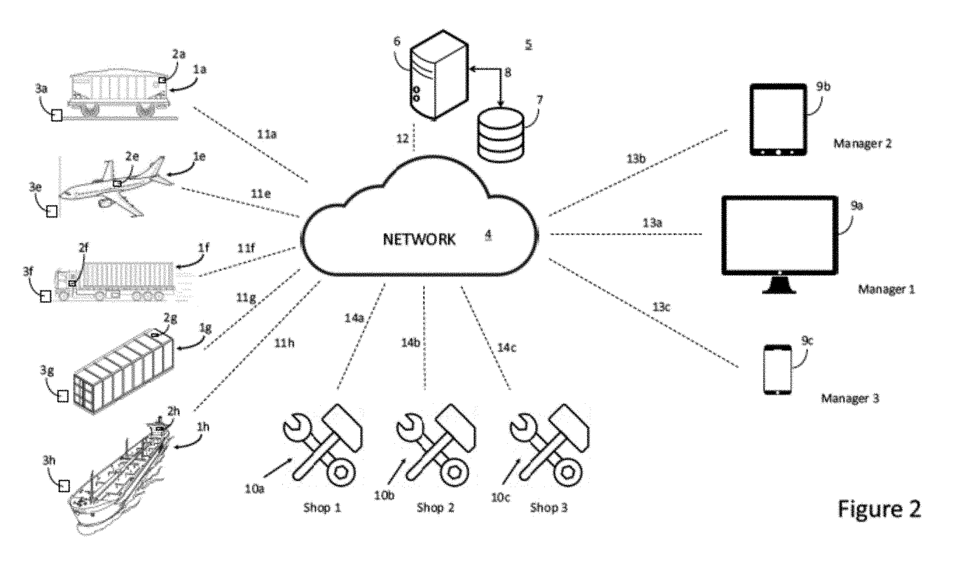

FIG. 2 is a comprehensive and cohesive system in accordance with another embodiment of the present invention. The process flow is generally the same as described above with respect to FIG. 1 and explained further below in connection with FIGS. 3-8. FIG. 2 is presented to illustrate that the system and method of the present invention is applicable to other types of shipping and/or storage units besides railcars. For example, the system shown in FIG. 2 includes a railcar 1a, a plane 1e, a truck 1f, a shipping container 1g, and a cargo ship 1h. Railcar 1a optionally includes sensor subsystem 2a, as described above. The system may obtain additional data regarding railcar 1a from sensor node 3a, as discussed above. Plane 1e may include a sensor subsystem 2e. The system may also obtain data associated with plane 1e via node sensor 3e, which may be located at an airport or other fixed location. Truck 1f may include a sensor subsystem 2f. The system may also obtain data associated with truck 1f via node sensor 3f, which may be located at a truck stop, near a roadway, at a loading facility, or in another fixed location. Shipping container 1g may include a sensor subsystem 2g. The system may also obtain data associated with shipping container 1g via node sensor 3g, which may be located at a loading facility, weight station, or other fixed location. Cargo ship 1h may include a sensor subsystem 2h. The system may also obtain data associated with cargo ship 1h via node sensor 3h, which may be located at a port, loading facility, docking station, or other fixed location.

FIG. 2 also includes the other elements shown in FIG. 1. For example, railcar la is connected to network 4 via network connection 11a, plane 1e is connected to network 4 via network connection 11e, truck 1f is connected to network 4 via network connection 11f, shipping container 1g is connected to network 4 via network connection 11g, and cargo ship 1h is connected to network 4 via network connection 11h. The system also includes user devices 9a-c, which are connected to network 4 via network connections 13a-c, respectively. Subsystem 5, including server 6, database 7, and server-to-database connection 8, is connected to network 4 via network connection 12. Finally, repair shops 10a-c are connected to network 4 via network connections 14a-c, respectively. The remainder of the system works as described herein.

FIG. 3 depicts a sample process flow showing various aspects and system decisions in a preferred embodiment of the present invention. The process flow of the system is broken down in FIG. 3 into three related parts: (1) an Asset Health Management phase 100; (2) a Shopping phase 200; and (3) a Shop Billing phase 300. In the Asset Health Management phase 100 of the process, process flow block 101 indicates that railcars and approved shop data is first loaded into the system. Here, a railcar owner or fleet manager will load into the system information about the cars within a fleet, such as identifying information, age, previous maintenance, or other metrics that may be useful for tracking and managing maintenance needs. Next, as shown in block 102, the user sets up repair metrics, such as average abatement cost, average revenue move, average repair costs, and information regarding whether the car is on or off lease. The user next sets up configurable rules, as shown in block 103. These rules are priority-ordered metrics based on information about a particular railcar in question. For example, one configurable rule could state that a flag should be triggered if an air brake test is recommended within the next 30 calendar days. In this event, an increased risk score would be assigned to the particular car when the recommended brake test was within the 30-day window. If the recommended brake test were more than 30 days away, no flag would be triggered. The system allows the owner or fleet manager to assign a risk score for each type of data. Additionally, the system allows the railcar owner to prioritize the elements in the risk engine. For example, if the user considers alerts related to brakes to be more important than alerts related to wheel wear, he or she can position the alerts appropriately, such that the brake alert score is figured into the overall risk score before the wheel alert score. A user's preferred ordering of risk elements may be determined by a number of factors such as the age of a fleet, whether a particular car is carrying hazardous or non-hazardous materials, etc.

The next part of the Asset Health Management Phase 100 involves system set-up 104, where data is pulled from an internal database (which can be local or stored remotely) or from a third-party industry database. This data can include information obtained from sensors attached to the railcars and/or railroads and is used to help assess the risk factors and needs of the railcars in a given fleet. The system next allows the user to create a fleet, as shown in block 105. When a fleet is created, the system associates rail cars that are loaded into the system in block 101 with each other and assigns them to a fleet manager or owner. Next, in block 106, the system allows the user to group and track railcars by various features or characteristics such as build date, car type, commodity, or car number series. Next, as shown in block 107, the system assesses a risk profile and creates an RID Report. As explained above, the rules risk engine uses the priority-based scoring system to apply the rules (defined in step 103) to the data (obtained in step 104). For example, polled data may indicate that a particular railcar (1) is carrying a hazardous material, (2) has a brake test due in 20 days, and (3) has a condemnable alert in the form of a wheel misalignment. In one particular example, the first risk rule in the system considers whether there is a wheel misalignment. The rule may be, e.g., that a car should be assigned a 65% risk score if there is a wheel misalignment for a car carrying a non-hazardous material or an 85% risk score if there is a wheel misalignment for a car carrying a hazardous material. In this case, the risk score contribution from the wheel misalignment alert would be 85%. If there were then a secondary risk rule stating that 10% risk should be added to a car due for a brake test within 30 days, the total risk score would be 95%. This risk information may be reported in a risk report through a graphical user interface, as discussed further below. Optionally, the system can send e-mail or text alerts to an owner or fleet manager when, for example, a railcar within a managed fleet has a risk score higher than a preset notification limit. Additionally, the system can create RID reports for every car in a fleet and send a summary to the owner or manager on a periodic basis, as preset within system preferences.

The system next analyzes risk versus repair cost and generates a potential savings report, as shown in block 108. Once the initial steps outlined in the Asset Health Management Phase 100 have been completed, a user can monitor reported data and make an informed decision 109 whether to initiate a request for repairs via the Shopping Phase 200 or End the session 400.

If a user decides to shop for repairs (yes in decision block 109), the system next enters the Shopping Phase 200. The first decision 201 in Shopping Phase 200 is whether to shop via bidding. If the user decides to shop via bidding (yes in block 201), the system enters block 202, where the program can send requests for proposal (“RFPs”) to shops near the destination SPLC. The system also preferably allows the user, via the graphical user interface, to de-select shops that the user does not want to include in the RFP list. Once a group of shops is selected, the system sends RFPs to the selected shops and waits for responses. Next, as shown in block 203, the system receives bids from shops with estimates or quotes for performing the desired repairs or maintenance. From here, the system allows the user to select a shop to perform the repair or maintenance, as shown in block 204. Note: if the user decides not to shop via bidding (block 201), the user can simply select a desired shop at block 204. Once a shop is selected in block 204, a waybill is generated, as depicted in block 205. Next, the system determines whether the selected shop has an existing shop record or object within the system database, at step 206. If so, the system transmits to the shop record via web service (step 207). And if the shop is enabled with RMS integration by providing the security key, then the shopping information, i.e., the list of cars and the industry data is transmitted electronically via a web service call to the RMS system utilized by the shop. If the selected shop is not a shop of record within the system (i.e., does not have a shop record or object within the system database), the user may create a shop record. First, the system must determine at decision step 208 whether the user has Insight Billing available. Insight Billing Module is a two-way communication platform that allows shops and car owners to exchange repair related information, upload and receive estimates and invoices and track progress of car(s) during the shopping process. If the user does not (no in decision 208), the user cannot shop via the program, and the process ends 400. If the user has access to Insight Billing (yes in decision 208), the system determines—at step 209—whether the desired shop has access to the system. If not (no in decision 209), the system must proceed to step 210, where the car owner initiates the shop registration process by creating shop records and shop contact records or objects for storage in the system database. The system will trigger the shop and shop contact validation process that will result in access to the shop side of the system. Additionally, shops that want to participate as participating businesses may add themselves to the system by creating shop records or objects for storage in the system database.

Once a shop is selected and it is determined (at step 209) that the shop has access to Insight Billing, the system proceeds to the Shop Billing phase 300. The first step in this phase is for the system to notify the selected shop (step 301). This is done through the system by sending an alert to the shop. The railcar at issue is then sent to the shop where an inspection 302 is performed. Next, the shop submits an estimate to the railcar owner or operator, as shown in step 303. The estimate is preferably sent within the application and can be retrieved by the user via the graphical user interface within the program. The user must then make an approval decision 304. If the user does not indicate that the estimate is approved, the shop may submit a new estimate (step 303 again). If the estimate is approved in step 304, the shop proceeds with the repair (step 305). Throughout the repair, the shop may determine (at step 306) whether additional repairs are required. If so, the shop can submit new estimates for these repairs (step 303 again), and the process flow continues as before. If no supplemental repairs are identified in step 306, the shop completes the repairs and submits an invoice, at step 307. The invoice is retrievable through the system via the GUI. The user then either approves or rejects the invoice at step 308. If the invoice is rejected (which happens through the system), the system goes back to step 307 and allows the shop to correct any errors in the invoice. If the invoice is approved at step 308, the car owner pays for the repairs (step 309), which may be facilitated through the system. Car repair details are sent to analytics (step 310) so the car's profile may be updated within the system database and so general trends can be recorded for later processing. At this point, the process is complete and the program may end 400.

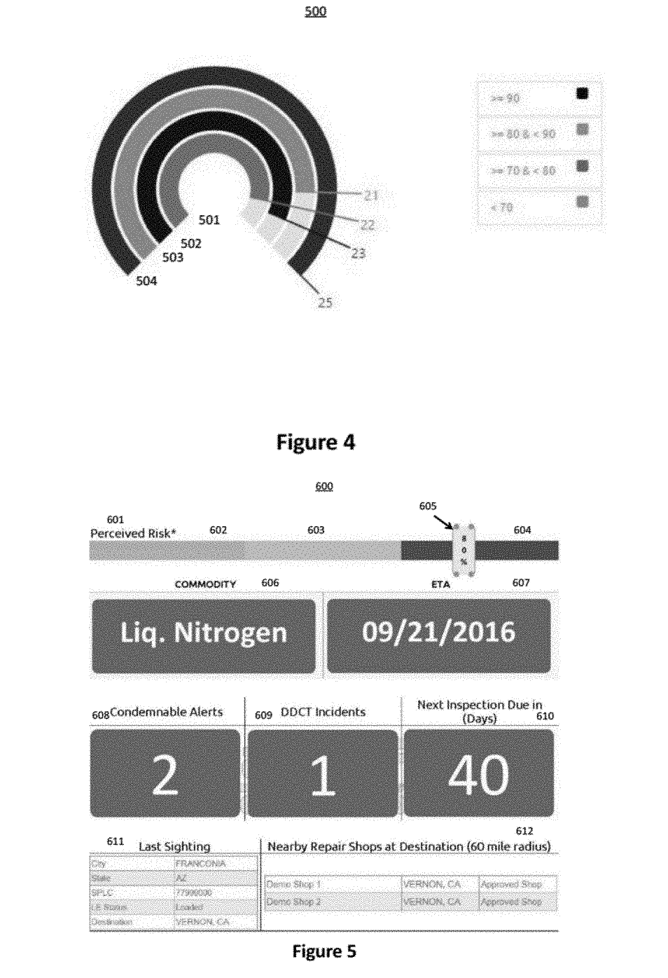

FIG. 4 depicts a sample view of a graphical user interface of a system in accordance with a preferred embodiment of the present invention, showing a sample risk factor report. The preferred embodiment of the present invention integrates real-time industry data obtained directly or sourced from one or more third parties that collect industry data and/or data about individual rail cars. This data includes current equipment health, alerts, and status data. The system also preferably builds an asset management system based on the user's pre-set rules and graphically presents a dynamic risk factor 500 so the user can make proactive repair and shopping decisions. In the preferred embodiment of the graphical user interface, the dynamic risk factor 500 includes concentric rings corresponding to railcars within individual risk bands. For example, in the example featured in FIG. 4, the user (railcar owner or fleet operator, for example) has a fleet of 90 railcars, 22 of which have a risk score of below 70 (band 501), 23 of which have a risk score of between 70 and 80 (band 502), 21 of which have a risk score between 80 and 90 (band 503), and 25 of which have a risk score of 90 or greater (band 504). Other configurations of data are possible and are contemplated as being within the scope of the present invention. The reporting via a graphical user interface allows a user to view statistical data about their fleets quickly and efficiently. Providing comparative information as in this example allows a user to determine quickly the relative health of the railcars within their fleet.

FIG. 5 depicts a sample view of a graphical user interface of a system in accordance with a preferred embodiment of the present invention, showing a sample Railcar Information Digest Report (RID) 600. The RID 600 provides real-time data against the user's configured Risk Rules Engine to determine the probability that equipment will be repaired outside a Contract Repair Shop. For example, as shown in the example of FIG. 5, the RID 600 features a Perceived Risk 601, featuring three color-coded bands 602, 603, and 604, corresponding to low, medium, and high-risks. The actual calculated risk for the given railcar is depicted in a call-out box 605, as shown. In the example of FIG. 5, the actual calculated risk shown in box 605 is 80% (based on the weighted and prioritized application of defined rules as discussed above), within the high-risk band 604. The RID 600 also includes other information such as an identification of the carried commodity 606, the estimated time for the railcar arrival 607, the number of condemnable alerts 608, the number of DDCT Incidents 609, and the number of days until the next scheduled inspection of the car 610. At the bottom of the user interface, the RID 600 lists the location of the last sighting of the car 611 and a listing of nearby shops 612, which includes information such as the name of the shop, the location, and whether the shop is on the approved list as entered by the user in the system.

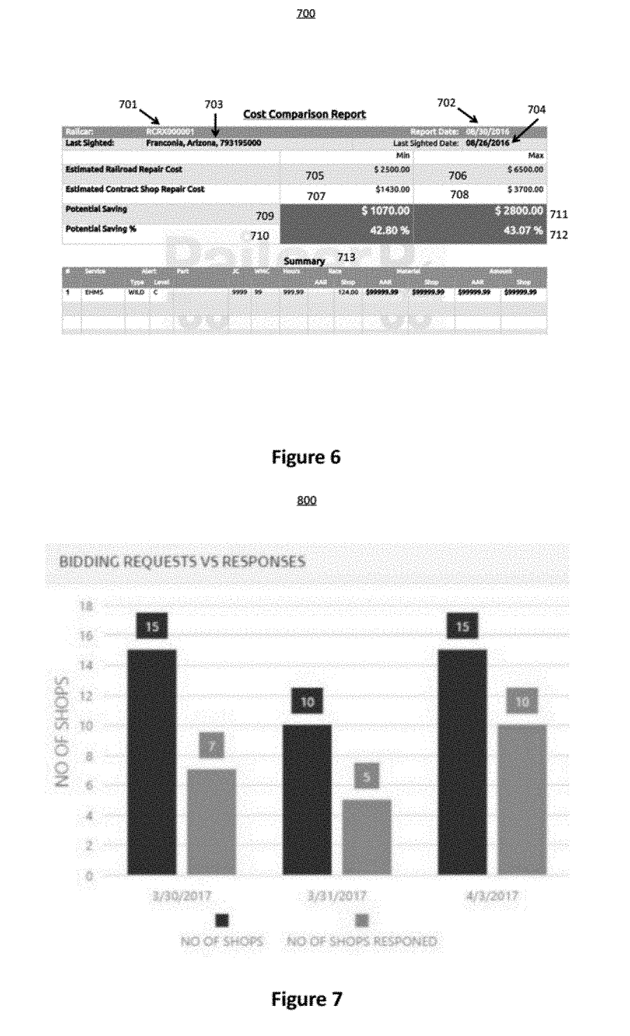

FIG. 6 depicts a sample view of a graphical user interface of a system in accordance with a preferred embodiment of the present invention, showing a sample Cost Comparison Report 700. The Cost Comparison Report 700 allows a user to analyze cost to repair equipment in a Contract Repair Shop against industry cost of repairs by a Railroad. It also provides the user with the cost comparison between different Contract Repair Shops. For example, in FIG. 6, the Cost Comparison Report 700 includes an identification 701 of the Railcar for which the report was generated (RCRX000001) and the Report Date 702 (which is Aug. 30, 2016, in the example). The Cost Comparison Report 700 also shows the last reported sighting 703 of the car (e.g., Franconia Ariz., 793195000) and the date 704 of the last sighting (Aug. 26, 2016). The Cost Comparison Report 700 next shows the results of the data processing as performed by the system, including minimum and maximum costs and savings based on the data collected by the system. For example, in FIG. 6, the minimum estimated railroad repair cost 705 is $2500.00, and the maximum estimated railroad repair cost 706 is $6500.00. These estimated railroad repair costs refer to the cost that would be incurred if a railroad undertook the repair or maintenance itself (i.e., in the absence of action by a user of the present invention) and are based on job codes and associated prices as provided by, e.g., the American Association of Railroads suggested price list. In the example provided, the minimum estimated contract shop repair cost 707 is $1430.00, and the maximum estimated contract shop repair cost 708 is $3700.00. This estimated contract shop repair cost corresponds to the cost of approved shops included in the system directory and includes factors such as labor rates based on shop information, estimated number of labor hours (based on, e.g., job code, location, reason for repair, etc.), and price of new versus refurbished parts. Thus, in the example depicted in FIG. 6, the minimum potential savings 709 is $1070.00, or a minimum potential savings percentage 710 of 42.80%, and the maximum potential savings 711 is $2800.00, or a maximum potential savings percentage 712 of 43.07%. The Cost Comparison Report 700 also shows a summary 713, which features information such as listing of all the equipment health management alerts on that car and corresponding potential railroad and contract shop repair charges.

FIG. 7 depicts a sample view of a graphical user interface of a system in accordance with a preferred embodiment of the present invention, showing a sample report of available shops that have responded to a request for repair or maintenance quotes 800. The chart includes data over time, which allows the user to track responsiveness of shops in a particular area or with respect to particular cars or issues.

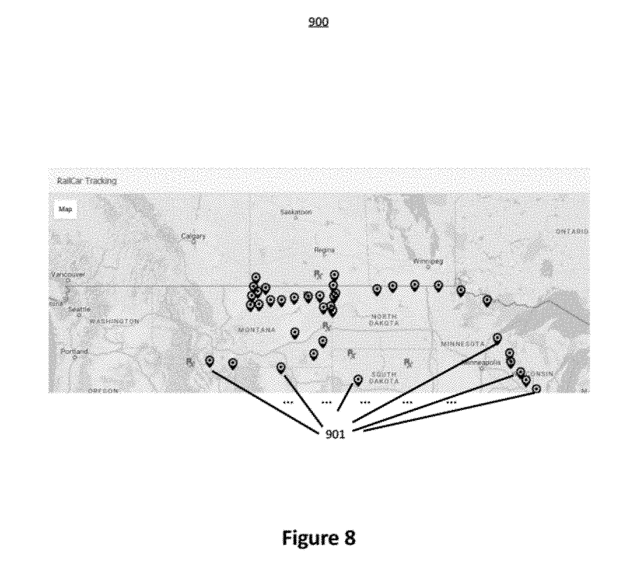

FIG. 8 depicts a sample view of a graphical user interface of a system in accordance with a preferred embodiment of the present invention, showing a sample Tracking Report 900 of railcars within a fleet. Railcars may be tracked and presented in the graphical user interface in a number of ways. For example, railcar location may be determined using GPS information or may be based on the last known location of a railcar (as determined by, e.g., data obtained directly through sensors or from a third party that tracks and reports information about railcars). The map preferably features icons 901 representing the locations of cars within a fleet. The RailCarRx icons represents the nearby shops that are using RailCarRx—RMS system that can be included in the bidding process.

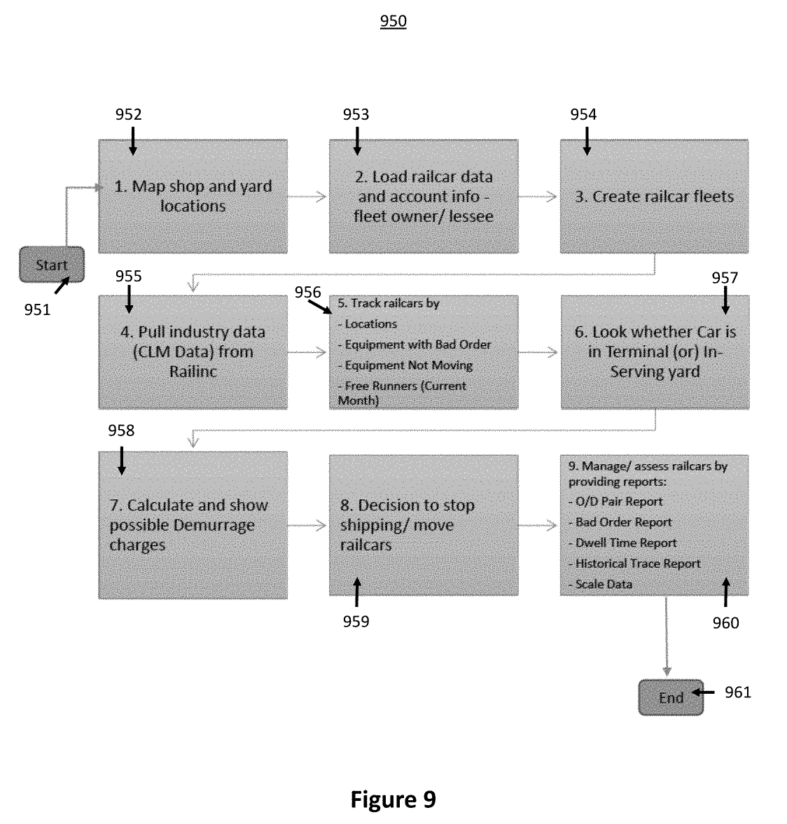

FIG. 9 depicts a sample process flow showing various aspects and system decisions in a Tracking Process Module 950 of the present invention. The Tracking Process Module 950 is an additional feature of the overall system described herein, and works in conjunction with the elements described in, e.g., FIG. 3. As discussed herein, the present invention is generally designed to assist railcar owners and fleet managers manage their maintenance costs. One major cost that railcar owners and managers face is demurrage charges. Typically, a car owner or manager enters into contracts with railroads to have goods shipped between locations. These locations include serving yards (also sometimes called service yards), where cars sit while they are idle (i.e., not moving between locations). A contract may allow a railcar owner to store, e.g., 50 railcars in a given serving yard. If the owner or manager has a 51st car that is destined for a location (or node along the railroad), the owner or manager will have to make a decision whether to exceed the contracted-for capacity at the serving yard (which will subject the owner to demurrage charges) or move the car into a service station for scheduled or other needed repairs. Similarly, the owner may decide that it is more cost effective to leave a car at a repair shop or service station (and pay a storage fee) rather than move the car into a serving yard, which could result in demurrage charges.

A user of the system can select a tracking option within the graphical user interface of the system, which initiates the Start 951 of the Tracking Process Module 950. First, at 952, the system maps shop and yard locations. This is accomplished by pulling known locations for repair shops and railcar yards from within the system database. Preferably, the file system stores this information such that serving yards are associated with repair shops. Next, at 953, the system loads railcar data and account information, which is given to the system manager by customers and stored in the database for, e.g., tracking purposes. At 954, the system allows the user to create railcar fleets. As with block 105 in FIG. 3, the system next allows the user to create a fleet of railcars. These fleets can be the same as those discussed with respect to FIG. 3, in which case fleet information already loaded into the system is used for the Tracking Process Module 950. At step 955, the system pulls data from an internal database or from a third-party entity, such as Railinc. This data includes CLM Data (i.e., Car Location Movement Data) and other information (discussed herein) that is used to determine risk information associated with a given railcar or hardware component of said railcar. Typically, railroads send data for the railcars on their track to a third-party entity, which then makes the information available to railcar owners or managers for their use.

The system also, as shown at 956, tracks railcars within a fleet. Tracking is done via location information and can group and present railcars to the user based on location, equipment with bad orders (e.g., those in need of repair or with other maintenance issues flagged), idle equipment (i.e., equipment not moving in figure 957), and/or free runners (i.e., one-time loaner cars provided by railroads).

The system next determines, at step 957, whether a given railcar is in a terminal or in a serving yard. This determination includes comparison of location information of the railcar (e.g., GPS location, last-known location data, or other geographical indicator) with the shop and yard location information pulled from memory at step 952. For example, the system may use event information indicating whether a given railcar was last seen in terminal or in serving yard, together with actual placement information and time between events. The system can determine, based on the time between events and the presence or absence of Pull or Departure events, whether a car is deemed to be in a serving yard or at a terminal. The processor within the system next calculates possible demurrage charges (e.g., based on contractual costs, which may be programmed into the system) and displays them to the user via the graphical user interface at step 958. Next, at 959, the system accepts input from the user indicating whether the user desires to maintain the idle state of the railcar or move it to avoid additional charges. The decision information is used to generate a waybill to move the given railcar, if necessary based on the user input.

The processor within the system can then generate reports for the user at step 960, which can be displayed on the graphical user interface, stored in local memory, and/or uploaded to a remote system for storage in a database. These reports may include an O/D Pair Report (e.g., origination-destination reports, used to assess performance trends for railcars that move back and forth between common locations), a Bad Order Report (e.g., reports indicating railcars in need of maintenance or other actions), a Dwell Time Report (e.g., reports indicating the total time necessary for railcars to get in and out of a given location or node along a railroad), a Historical Trace Report (e.g., reports indicating where a given railcar has traveled, used to determine total mileage), and/or Scale Data (e.g., weight of loaded railcars scaled by a railroad). From there, at 961, the user can end the Tracking Process Module 950.

Although the invention has been described with reference to one or more particular embodiments, this description is not meant to be construed in a limiting sense. Various modifications of the disclosed embodiments as well as alternative embodiments of the invention will become apparent to persons skilled in the art upon reference to the description of the invention. It is therefore contemplated that the appended claims will cover any such modifications or embodiments that fall within the scope of the invention.

1. A computer-implemented method for managing maintenance of one or more railcars in a fleet comprising:
identifying a geographical location of a railcar;
receiving sensor data associated with said railcar;
retrieving, from a database, a maintenance report for said railcar, wherein said maintenance report includes at least a first maintenance history for a first hardware component of said railcar and a first maintenance schedule for said first hardware component;
applying, with a processor, a risk rules engine to determine a first risk score for said railcar, wherein said first risk score is based at least in part on said geographical location, said sensor data, said first maintenance history, and said first maintenance schedule; and
displaying said first risk score via a graphical user interface.

2. The computer-implemented method of claim 1, wherein said sensor data includes at least a weight of said railcar.

3. The computer-implemented method of claim 1, further comprising:
updating said maintenance report with said first risk score; and
saving said updated maintenance report in said database.

4. The computer-implemented method of claim 1, wherein said maintenance report further includes at least a second maintenance history for a second hardware component of said railcar and a second maintenance schedule for said second hardware component.

5. The computer-implemented method of claim 4, wherein said risk score is further based at least in part on said second maintenance history for said second hardware component and said second maintenance schedule for said second hardware component.

6. The computer-implemented method of claim 5, wherein said risk score is further determined by performing a risk ranking of at least one factor associated with said first hardware component and at least one factor associated with said second hardware component.

7. The computer-implemented method of claim 1, wherein said first hardware component is a first railcar wheel.

8. The computer-implemented method of claim 7, wherein said second hardware component is a second railcar wheel.

9. A computer-implemented method for managing maintenance of one or more railcars in a fleet comprising:
identifying a first geographical location of a first railcar;
identifying a second geographical location of a second railcar;
receiving a first set of sensor data associated with said first railcar;
receiving a second set of sensor data associated with said second railcar;
retrieving, from a database, a first maintenance report for said first railcar, wherein said first maintenance report includes at least a first maintenance history for a first hardware component of said first railcar and a first maintenance schedule for said first hardware component;
applying, with a processor, a risk rules engine to determine a first risk score for said first railcar, wherein said first risk score is based at least in part on said first geographical location, said first set of sensor data, said first maintenance history, and said first maintenance schedule;
displaying said first risk score via a graphical user interface;
retrieving, from said database, a second maintenance report for said second railcar, wherein said second maintenance report includes at least a second maintenance history for a second hardware component of said second railcar and a second maintenance schedule for said second hardware component;
applying, with said processor, a risk rules engine to determine a second risk score for said second railcar, wherein said second risk score is based at least in part on said second geographical location, said second set of sensor data, said second maintenance history, and said second maintenance schedule; and
displaying said second risk score via a graphical user interface.

10. The computer-implemented method of claim 9, wherein said first sensor data includes at least a weight of said first railcar.

11. The computer-implemented method of claim 9, further comprising:
updating said first maintenance report with said first risk score; and
saving said updated first maintenance report in said database.

12. The computer-implemented method of claim 9, wherein said first maintenance report further includes at least a third maintenance history for a third hardware component of said first railcar and a third maintenance schedule for said third hardware component.

13. The computer-implemented method of claim 12, wherein said first risk score is further based at least in part on said third maintenance history for said third hardware component and said third maintenance schedule for said third hardware component.

14. The computer-implemented method of claim 13, wherein said first risk score is further determined by performing a risk ranking of at least one factor associated with said first hardware component and at least one factor associated with said third hardware component.

15. The computer-implemented method of claim 9, wherein said first hardware component is a first railcar wheel.

16. The computer-implemented method of claim 15, wherein said second hardware component is a second railcar wheel.

17. The computer-implemented method of claim 16, wherein said third hardware component is a third railcar wheel.

18. A computer-implemented method for managing maintenance of one or more railcars in a fleet comprising:
identifying a first geographical location of a first railcar;
identifying a second geographical location of a second railcar;
receiving a first set of sensor data associated with said first railcar;
receiving a second set of sensor data associated with said second railcar;
retrieving, from a database, a first maintenance report for said first railcar, wherein said first maintenance report includes at least a first maintenance history for a first hardware component of said first railcar and a first maintenance schedule for said first hardware component, and wherein said first maintenance report further includes at least a second maintenance history for a second hardware component of said first railcar and a second maintenance schedule for said second hardware component;
applying, with a processor, a risk rules engine to determine a first risk score for said first railcar, wherein said first risk score is based at least in part on said first geographical location, said first set of sensor data, said first maintenance history, said first maintenance schedule, said second maintenance history, and said second maintenance schedule;
displaying said first risk score via a graphical user interface;
retrieving, from said database, a second maintenance report for said second railcar, wherein said second maintenance report includes at least a third maintenance history for a third hardware component of said second railcar and a third maintenance schedule for said third hardware component, and wherein said second maintenance report further includes at least a fourth maintenance history for a fourth hardware component of said second railcar and a fourth maintenance schedule for fourth second hardware component;
applying, with said processor, said risk rules engine to determine a second risk score for said second railcar, wherein said second risk score is based at least in part on said second geographical location, said second set of sensor data, said third maintenance history, said third maintenance schedule, said fourth maintenance history, and said fourth maintenance schedule; and
displaying said second risk score via said graphical user interface.

19. The computer-implemented method of claim 18, wherein said first risk score is further determined by performing a first risk ranking of at least one factor associated with said first hardware component and at least one factor associated with said second hardware component.

20. The computer-implemented method of claim 19, wherein said second risk score is further determined by performing a second risk ranking of at least one factor associated with said third hardware component and at least one factor associated with said fourth hardware component.
